(19) United States
(12) Patent Application Publication
(10) Pub. No.: US 2025/0086686 A1
(43) Pub. Date: Mar. 13, 2025

(54) SYSTEMS AND METHODS FOR PROVIDING A SEARCH RESULT

(71) Applicant: Capital One Services, LLC, McLean, VA (US)

(72) Inventors: Arun GOPALAKRISHNA, McKinney, TX (US); Adam Roy PAYNTER, Plano, TX (US); Cole COEN, Celina, TX (US); Ravi KALIDINDI, Mckinney, TX (US); Humberto HERNANDEZ TORRES, Plano, TX (US); Akash GULATI, Frisco, TX (US)

(21) Appl. No.: 18/465,532

(22) Filed: Sep. 12, 2023

(51) Int. Cl. G06Q 30/0601; G06Q 10/087

(52) U.S. Cl. CPC G06Q 30/0627; G06Q 10/087; G06Q 30/0639

(57) ABSTRACT

A system receives a search query that includes one or more entity characteristic parameters and one or more item characteristic parameters. The system identifies, based on the one or more entity characteristic parameters of the search query, a set of one or more entities. The system determines an entity order associated with the set of one or more entities, and determines a respective quantity of item display slots for each entity of the set of one or more entities. The system performs, based on the one or more item characteristic parameters, the entity order, and the respective quantity of item display slots for each entity of the set of one or more entities, an item search to generate a search result that identifies a plurality of items provided by the set of one or more entities. The system then provides the search result.

### BACKGROUND

A search engine may be used to perform a web search. For example, a user may input a search query via a web browser of a user device, which may cause the search engine to return a search result based on the search query.

### SUMMARY

Some implementations described herein relate to a system for providing search results. The system may include one or more memories and one or more processors communicatively coupled to the one or more. The one or more processors may be configured to receive, from a user device, a search query that includes one or more entity characteristic parameters and one or more item characteristic parameters. The one or more processors may be configured to identify, based on the one or more entity characteristic parameters of the search query, one or more entities associated with the one or more entity characteristic parameters. The one or more processors may be configured to identify a set of one or more entities, of the one or more entities, that have a particular attribute. The one or more processors may be configured to determine an entity order associated with the set of one or more entities. The one or more processors may be configured to determine a respective quantity of item display slots for each entity of the set of one or more entities. The one or more processors may be configured to perform, based on the one or more item characteristic parameters, the entity order, and the respective quantity of item display slots for each entity of the set of one or more entities, an item search to generate a search result that identifies a plurality of items provided by the set of one or more entities. The one or more processors may be configured to transmit, to the user device, the search result to allow the user device to display the search result on a screen of the user device.

Some implementations described herein relate to a non-transitory computer-readable medium that stores a set of instructions. The set of instructions, when executed by one or more processors of a system for providing search results, may cause the system for providing search results to receive a search query that includes one or more entity characteristic parameters and one or more item characteristic parameters. The set of instructions, when executed by one or more processors of the system for providing search results, may cause the system for providing search results to identify, based on the one or more entity characteristic parameters of the search query, a set of one or more entities. The set of instructions, when executed by one or more processors of the system for providing search results, may cause the system for providing search results to determine an entity order associated with the set of one or more entities. The set of instructions, when executed by one or more processors of the system for providing search results, may cause the system for providing search results to determine a respective quantity of item display slots for each entity of the set of one or more entities. The set of instructions, when executed by one or more processors of the system for providing search results, may cause the system for providing search results to perform, based on the one or more item characteristic parameters, the entity order, and the respective quantity of item display slots for each entity of the set of one or more entities, an item search to generate a search result that identifies a plurality of items provided by the set of one or more entities. The set of instructions, when executed by one or more processors of the system for providing search results, may cause the system for providing search results to provide the search result.

Some implementations described herein relate to a method for providing search results. The method may include identifying, by a system and based on a search query, a set of one or more entities. The method may include determining, by the system, an entity order associated with the set of one or more entities. The method may include determining, by the system, a respective quantity of item display slots for each entity of the set of one or more entities. The method may include performing, based on the search query, the entity order, and the respective quantity of item display slots for each entity of the set of one or more entities, an item search to generate a search result that identifies a plurality of items provided by the set of one or more entities. The method may include providing the search result.

### BRIEF DESCRIPTION OF THE DRAWINGS

FIGS. 1A-1B are diagrams of an example associated with providing a search result, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with providing a search result, in accordance with some embodiments of the present disclosure.

FIG. 4 is a flowchart of an example process associated with providing a search result, in accordance with some embodiments of the present disclosure.

### DETAILED DESCRIPTION

The following detailed description of example implementations refers to the accompanying drawings. The same reference numbers in different drawings may identify the same or similar elements.

Some implementations described herein enable a processing system to provide, to a user device, a search result that identifies a plurality of items provided by a set of one or more entities (e.g., a set of one or more “preferred” entities). In this way, the processing system provides an optimized search result that includes items provided by preferred entities, which allows a user to quickly find and select (e.g., using an input component of the user device) an item provided by a preferred entity (e.g., without the processing system needing to provide one or more additional search results). As a result, the processing system conserves computing resources (e.g., processing resources, memory resources, communication resources, and/or power resources, among other examples) that would otherwise be used to generate the one or more additional search results. This also conservers computing resources of the user device that would be used to receive and display the one or more additional search results.

In many cases, a user of a user device, inputs into the user device a search query that is associated with an item, such as a product (e.g., a vehicle, electronic equipment, or furniture, among other examples). The search query is provided to a server (e.g., that hosts a search engine), which performs a search to generate a search result that identifies a plurality of items provided by a plurality of entities. In some cases, however, the search result may identify an item associated with a non-preferred entity (e.g., an entity with a low rating score, an entity of questionable authenticity, an entity not associated with a manufacturer of the item, or another type of non-preferred entity). Regardless, the server provides the search result to the user device, and thereby the user often selects the item associated with the non-preferred entity. This can result in a poor interaction experience for the user, which wastes computing resources (e.g., processing resources, memory resources, communication resources, and/or power resources, among other examples) of the user device. Further, because the search result includes the item associated with a non-preferred entity in the search result, the processing system often needs to use computing resources to provide one or more additional search results (e.g., to increase a likelihood that a user selects an item associated with a preferred entity, which can allow the user to have a better interaction experience).

In some implementations, a processing system receives a search query from a user device. The search query may be provided to the processing system to allow the processing system to provide a search result that identifies one or more items that are able to be provided by one or more entities (e.g., one or more providers, vendors, sellers, lenders, or other types of entities). For example, the search query may be associated with a product, such as a vehicle (e.g., the search query may be for a vehicle for purchase, for lease, or for rent by a user of the user device), and may be provided to the processing system to allow the processing system provide a search result that identifies one or more products (e.g., one or more vehicles) associated with the search query that are able to be provided by one or more entities (e.g., one or more vehicle providers, vendors, sellers, or lenders).

In some implementations, the search query includes one or more entity characteristic parameters and/or one or more item characteristic parameters. An entity characteristic parameter may be, for example, a characteristic of an entity that provides an item, such as a distance of an entity from a physical location associated with the search query, a type of the entity (e.g., an entity that sells new items or used items, or has an affiliation with a particular organization), or another type of characteristic of an entity. An item characteristic parameter may be, for example, a characteristic of the item, such as a price of the item (e.g., a maximum price or a minimum price), a condition of the item (e.g., new or used), a make and/or model of the item, or another type of characteristic of the item (e.g., a mileage, trim level, accident history, or other characteristic when the item is a vehicle).

The processing system identifies, based on the one or more entity characteristic parameters of the search query, a set of one or more entities (e.g., a set of one or more preferred entities, such as one or more entities with a high rating score, with non-questionable authenticity, or that are associated with a manufacturer of the item, or other types of preferred entities). The processing system then determines an entity order associated with the set of one or more entities (e.g., based on respective distances of the set of one or more entities from a physical location associated with the search query), and determines a respective quantity of item display slots for each entity of the set of one or more entities (e.g., based on respective inventory information of the set of one or more entities). An item display slot for an entity may correlate to a portion of a search result display page (e.g., wherein the display slot displays an item that is provided by the entity and that is included in a search result generated by the processing system).

Accordingly, in some implementations, the processing system performs an item search to generate a search result that identifies a plurality of items provided by the set of one or more entities. The search result includes items from the set of one or more entities based on the entity order of the one or more entities, and based on the respective quantity of item display slots for each entity. For example, the search result may include a first quantity of items provided by a first entity (e.g., that is associated with a first position of the entity order) that is equal to a quantity of item display slots for the first entity, a second quantity of items provided by a second entity (e.g., that is associated with a second position of the entity order) that is equal to a quantity of item display slots for the second entity, and so on. In this way, the processing system causes the search result to identify a representation (e.g., a “fair” representation) of items provided by the set of one or more entities based on the entity order (e.g., where the plurality of items identified by the search are associated with multiple entities, rather than just a single entity). Further, the search result, in many cases, only includes items from the set of one or more entities, which improves a quality of the search result.

The processing system then provides the search result to the user device, which allows a user to quickly find and select (e.g., using an input component of the user device) an item provided by an entity of the set of one or more entities (e.g., a preferred entity). As a result, as described above, the processing system conserves computing resources that would otherwise be used to generate one or more additional search results (e.g., that would otherwise need to be generated if search result were of lower quality). This also conservers computing resources of the user device that would be used to receive and display the one or more additional search results.

Notably, in some implementations, the processing system identifies the set of one or more entities, determines the entity order of the set of one or more entities, and determines the respective quantity of item display slots for each entity of the set of one or more entities, without communicating with another system or device. That is, the processing system performs these operations by communicating with a data structure (e.g., a database, or another type of data structure) that is included in and/or associated with the processing system. This allows the processing system to perform these operations quickly (e.g., in a time window that is less than or equal to 300 milliseconds, for example). Further, the processing system may perform a single item search associated with an entity of the set of one or more entities to identify a particular quantity of items provided by the entity that are to be identified by the search result. This reduces a number of item searches that need to be performed (e.g., as opposed to performing an item search for each item provided by an entity), which results in a reduced amount of time that is needed to generate the search result.

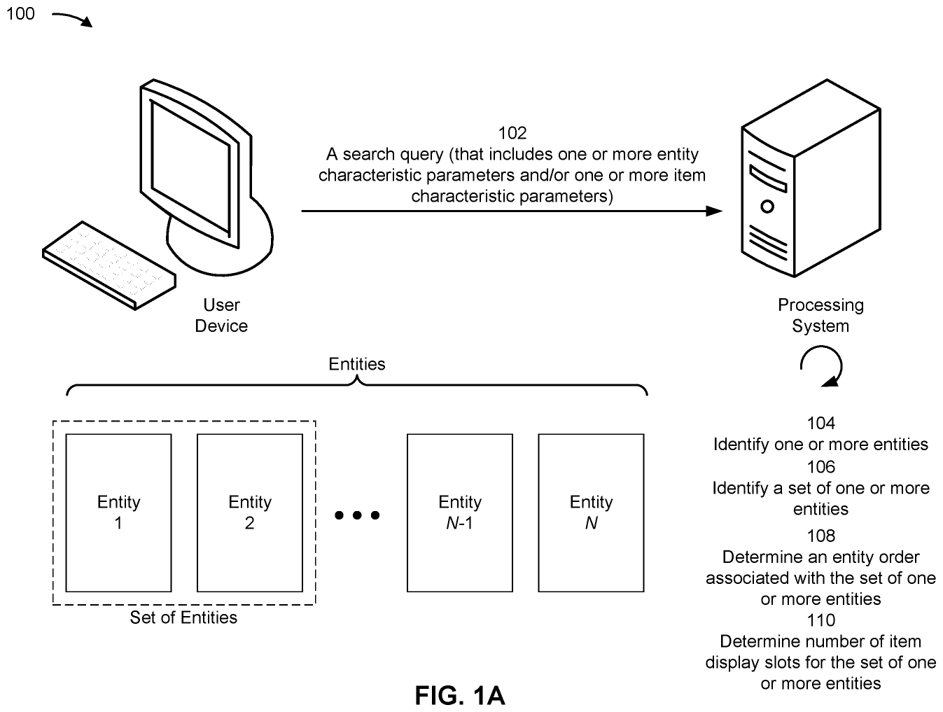

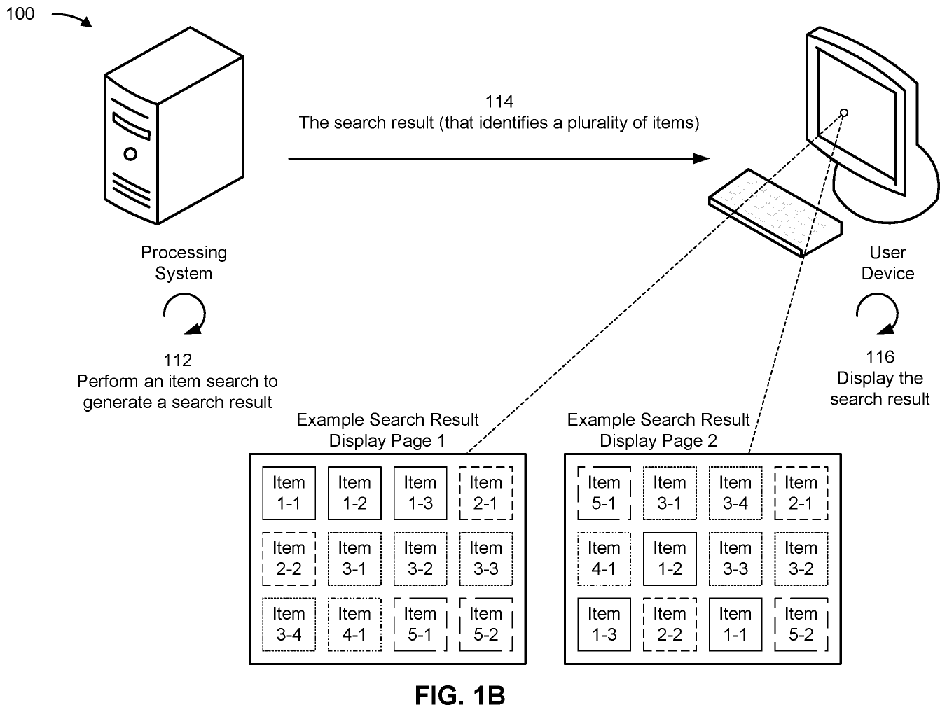

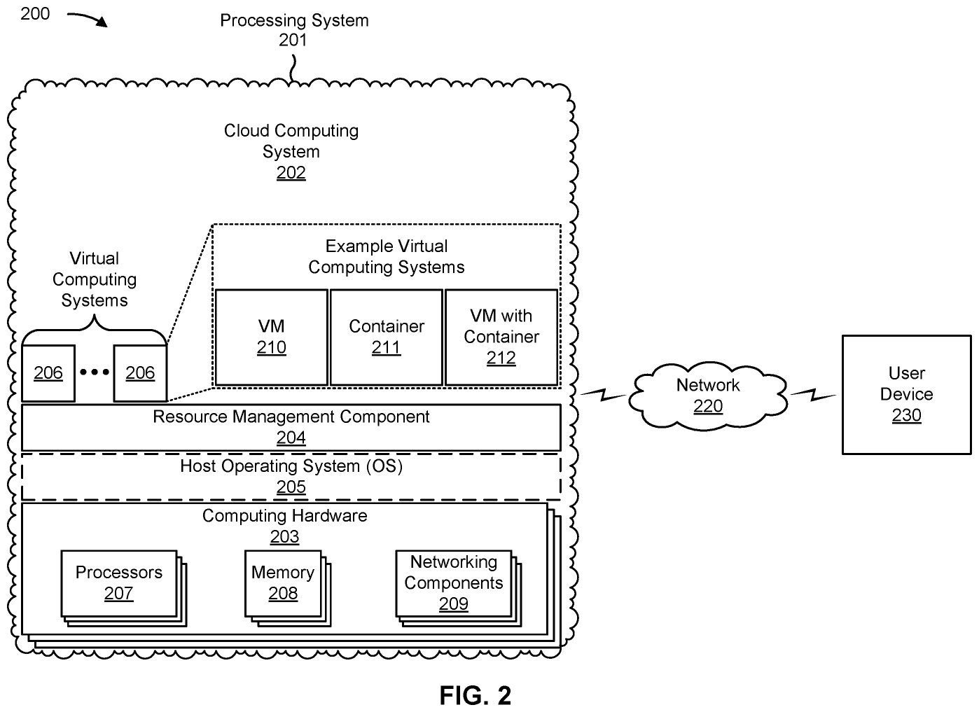

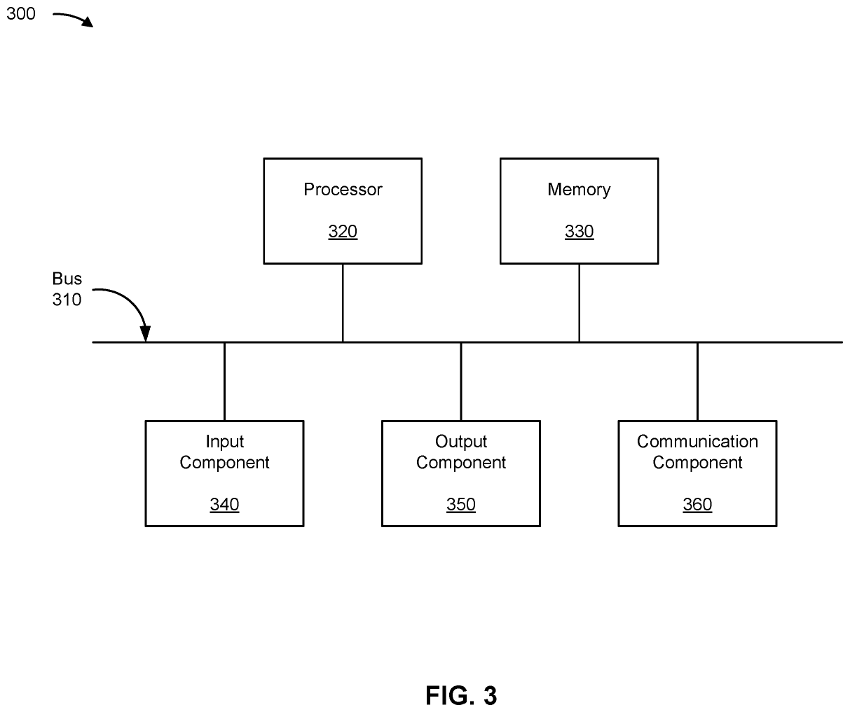

FIGS. 1A-1B are diagrams of an example 100 associated with providing a search result. As shown in FIGS. 1A-1B, example 100 includes a user device and a processing system. These devices are described in more detail in connection with FIGS. 2 and 3.

As shown in FIG. 1A, and by reference number 102, the provisioning system may receive a search query, such as from the user device. In some implementations, the user device may transmit the search query to the processing system, such as via a communication link between the user device and the processing system. Accordingly, the processing system may receive the search query from the user device (e.g., receive the search query via the communication link).

The search query may be associated with an item. That is, the search query may be provided to the processing system to allow the processing system to provide a search result that identifies one or more items associated with the search query that are able to be provided by one or more entities (e.g., one or more providers, vendors, sellers, lenders, or other types of entities). For example, the search query may be associated with a product, such as a vehicle (e.g., the search query may be for a vehicle for purchase, for lease, or for rent by a user of the user device), and may be provided to the processing system to allow the processing system provide a search result that identifies one or more products (e.g., one or more vehicles) associated with the search query that are able to be provided by one or more entities (e.g., one or more vehicle providers, vendors, sellers, or lenders).

In some implementations, the search query may include one or more entity characteristic parameters and/or one or more item characteristic parameters. An entity characteristic parameter may be, for example, a characteristic of an entity that provides the item. For example, an entity characteristic parameter may be a distance of an entity from a physical location associated with the search query, a type of the entity (e.g., an entity that sells new items or used items, or has an affiliation with a particular organization), or another type of characteristic of an entity. An item characteristic parameter may be, for example, a characteristic of the item. For example, an item characteristic parameter may be a price of the item (e.g., a maximum price or a minimum price), a condition of the item (e.g., new or used), a make and/or model of the item, or another type of characteristic of the item (e.g., a mileage, trim level, accident history, or other characteristic when the item is a vehicle). The search query may include the one or more entity characteristic parameters and/or the one or more item characteristic parameters to allow the processing system to provide a search result that is tailored to the preferences of the user of the user device (e.g., as indicated by the one or more entity characteristic parameters and/or the one or more item characteristic parameters).

As shown by reference number 104, the processing system may identify one or more entities (e.g., based on the search query). For example, as shown in FIG. 1A, the processing system may identify entities 1 to N. In some implementations, the processing system may search, based on the one or more entity characteristics of the search query, a data structure (e.g., that is included in the processing system and/or that is accessible to the processing system) that stores information associated with a plurality of entities to identify the one or more entities. As a specific example, when the search query includes a distance entity characteristic (e.g., that indicates that the processing system is to search for entities within a particular radius of a physical location associated with the search query), the processing system may search the data structure for one or more entities that have physical locations that satisfy the distance entity characteristic (e.g., that have distances that are less than or equal to the particular radius of the physical location associated with the search query). Accordingly, the one or more entities may be associated with the one or more entity characteristic parameters (e.g., that are included in the search query).

As shown by reference number 106, the processing system may identify a set of one or more entities of the one or more entities. For example, as shown in FIG. 1A, the processing system may identify entities 1 and 2 (of the entities 1 to N) as the set of one or more entities. The set of one or more entities may have a particular attribute. For example, each entity of the set of one or more entities may be associated with a particular organization or a particular program (e.g., a “preferred entity” organization or a “preferred entity” program). That is, the processing system may prioritize the set of one or more entities (over other entities of the one or more entities) in association with generating a search result, as further described herein. The processing system may communicate with the data structure to identify the set of one or more entities (e.g., because the data structure includes information that identifies whether an entity has the particular attribute).

As shown by reference number 108, the processing system may determine an entity order associated with the set of one or more entities. The entity order may indicate a sequence of the set of one or more entities. For example, the entity order may indicate that a first entity of the set of one or more entities is in a first position of the entity order, a second entity of the set of one or more entities is in a second position of the entity order, a third entity of the set of one or more entities is in a third position of the entity order, and so on.

In some implementations, the processing system may determine the entity order based on respective characteristics of the set of one or more entities. For example, the processing system may identify respective physical locations associated with the set of one or more entities, and may identify (e.g., based on the one or more entity characteristic parameters of the search query) a physical location associated with the search query. The processing system may therefore determine (e.g., based on the respective physical locations associated with the set of one or more entities), respective distances of the set of one or more entities from the physical location associated with the search query. Accordingly, the processing system may determine the entity order based on the respective distances of the set of one or more entities from the physical location associated with the search query (e.g., in a least-to-greatest distance order).

As shown by reference number 110, the processing system may determine a respective number of item display slots for each entity of the set of one or more entities. An item display slot for an entity may correlate to a portion of a search result display page associated with display of a search result that includes an item that is able to be provided by the entity, as further described herein (e.g., in association with FIG. 1B).

In some implementations, the processing system may determine the respective quantity of item display slots for each entity of the set of one or more entities based on respective characteristics of the set of one or more entities. For example, the processing system may identify, for each entity, item inventory information (e.g., that indicates a total number of items, regardless of characteristics of the items, that are available to be provided by the entity). The processing system may communicate with the data structure to obtain the item inventory information (e.g., because the data structure includes item inventory information for each entity). The processing system then may determine an inventory size of the entity. For example, the processing system may determine (e.g., based on the total number of items indicated by the item inventory information) whether the inventory size is “small” (e.g., less than or equal to a first size threshold), is “medium” (e.g., greater than the first size threshold and less than or equal to a second size threshold), or is “large” (e.g., greater than the second size threshold). Accordingly, the processing system may determine (e.g., based on the item inventory size of the entity) a quantity of item display slots for the entity. For example, each inventory size (e.g., small, medium, and large) may be associated with a particular quantity of item display slots, such as 2 item display slots for a small item inventory size, 3 item display slots for a medium item inventory size, and/or 5 item display slots for a large inventory size.

As shown in FIG. 1B, and by reference number 112, the processing system may perform an item search to generate a search result (e.g., based on the one or more item characteristic parameters of the search query, the entity order associated with the set of one or more entities, and/or the respective quantity of item display slots for each entity of the set of one or more entities). The search result may identify a plurality of items provided by the set of one or more entities. For example, the search result may identify a first quantity of items provided by a first entity of the set of one or more entities (e.g., where the first quantity of items is equal to the quantity of item display slots for the first entity), a second quantity of items provided by a second entity of the set of one or more entities (e.g., where the second quantity of items is equal to the quantity of item display slots for the second entity), a third quantity of items provided by a third entity of the set of one or more entities (e.g., where the third quantity of items is equal to the quantity of item display slots for the third entity), and so on.

In some implementations, to perform the item search to generate the search result, the processing system may identify a particular entity of the set of one or more entities. The particular entity may be associated with a particular position of the entity order (e.g., a first position, a second position, a third position, or so on). The processing system then may identify a particular quantity of item display slots for the particular entity (e.g., based on the respective quantity of item display slots for each entity of the set of one or more entities). Additionally, the processing system may identify a plurality of items provided by the particular entity (e.g., based on the one or more item characteristic parameters of the search query). For example, the processing system may search, based on the one or more item characteristic parameters, the data structure (or another data structure that is included in the processing system and/or is accessible to the processing system) to identify the plurality of items. Accordingly, the plurality of items may be said to satisfy the one or more item characteristic parameters. The processing system then may generate the search result to identify a particular quantity of items of the plurality of items provided by the particular entity, wherein the particular quantity of items is equal to the particular quantity of item display slots for the particular entity.

In some implementations, the processing system may generate the search result to identify a particular quantity of items, such as a quantity of items that can be displayed (e.g., by the user device) via a search result display page. For example, FIG. 1B shows example search result display pages with 12 item display slots, and, accordingly, the search result may identify 12 items. In some implementations, to generate the search result with the particular quantity of items, the processing system may serially perform an item search (e.g., as described above) for each entity of the one or more entities, according to the entity order, until the particular quantity of items is identified for the search result.

For example, the processing system may identify a first entity, of the set of one or more entities, that is associated with a first position of the entity order, and identify, based on the respective quantity of item display slots for each entity of the set of one or more entities, a first quantity of item display slots for the first entity. The processing system then may identify, based on the one or more item characteristic parameters, a first plurality of items provided by the first entity. Accordingly, the processing system may generate the search result to identify a first quantity of items of the first plurality of items provided by the first entity (e.g., wherein the first quantity of items is equal to the first quantity of item display slots for the first entity). When the first quantity of items is less than the particular quantity of items that are to be included in the search result, the processing system may perform a similar process again. For example, the processing system may identify a second entity, of the set of one or more entities, that is associated with a second position of the entity order, and may identify, based on the respective quantity of item display slots for each entity of the set of one or more entities, a second quantity of item display slots for the second entity. The processing system then may identify, based on the one or more item characteristic parameters, a second plurality of items provided by the second entity. Accordingly, the processing system may modify the search result to further identify the second quantity of items of the second plurality of items provided by the second entity (e.g., wherein the second quantity of items is equal to the second quantity of item display slots for the second entity). The processing system may continually perform a similar process until the search result includes the particular quantity of items that are to be included in the search result.

The processing system may cause the plurality of items of the search result to be ordered in the search result. In some implementations, the processing system may cause the plurality of items to be ordered based on the entity order. For example, the processing system may cause a first quantity of items (e.g., of a first plurality of items provided by a first entity), a second quantity of items (e.g., of a second plurality of items provided by a second entity), and so on, to be ordered in the search result according to relative positions of the first entity, the second entity, and so on, in the entity order. As a particular example, as shown in FIG. 1B in association with example search result display page 1, the search result may include items 1-1 through 1-3 from a first entity in a first position of the entity order, items 2-1 through 2-2 from a second entity in a second position of the entity order, items 3-1 through 3-4 from a third entity in a third position of the entity order, item 4-1 from a fourth entity in a fourth position of the entity order, and items 5-1 through 5-2 from a fifth entity in a fifth position of the entity order, where the items are ordered (e.g., left-to-right, top-to-down) according to the relative positions of the entities in the entity order.

Alternatively, the processing system may cause the plurality of items to be ordered in the search result based on a particular item characteristic parameter of the one or more item characteristic parameters (e.g., that are included in the search query). As a particular example, as shown in FIG. 1B in association with example search result display page 2, the search result may include the items 1-1 through 1-3, the items 2-1 through 2-2, the items 3-1 through 3-4, the item 4-1, and the items 5-1 through 5-2, where the items are ordered (e.g., left-to-right, top-to-down) according to a particular item characteristic parameter (and not the relative positions of the entities in the entity order), such as in a least-to-greatest price order.

As shown by reference number 114, the processing system may transmit the search result, such as to the user device. In some implementations, the processing system may transmit the search result to the user device, such as via the communication link between the user device and the processing system. Accordingly, the user device may receive the search result from the processing system (e.g., receive the search result via the communication link).

As shown by reference number 116, the user device may display the search result (e.g., on a screen of the user device). That is, the user device may display the plurality of items identified by the search result based on the order of the plurality of items in the search result. In some implementations, the user device may display (e.g., left-to-right, top-to-down) the plurality of items on a search result display page, where each item, of the plurality of items, is displayed in a respective item display slot (e.g., a portion of the search result display page) based on the order. In a particular example, as shown in FIG. 1B in association with the example search result display page 1, the user device may display the plurality of items may in the order that is associated with the entity order (e.g., the items 1-1 through 1-3, the items 2-1 through 2-2, the items 3-1 through 3-4, the item 4-1, and the items 5-1 through 5-2 are displayed according to the relative positions of the items' corresponding entities in the entity order). In another particular example, as shown in FIG. 1B in association with the example search result display page 2, the user device may display the plurality of items in the order that is associated with particular item characteristic parameter, of the one or more item characteristic parameter, that is included in the search query, such as in a least-to-greatest price order.

As indicated above, FIGS. 1A-1B are provided as an example. Other examples may differ from what is described with regard to FIGS. 1A-1B.

FIG. 2 is a diagram of an example environment 200 in which systems and/or methods described herein may be implemented. As shown in FIG. 2, environment 200 may include a processing system 201, which may include one or more elements of and/or may execute within a cloud computing system 202. The cloud computing system 202 may include one or more elements 203-212, as described in more detail below. As further shown in FIG. 2, environment 200 may include a network 220, and/or a user device 230. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the processing system 201 may include one or more elements 203-212 of the cloud computing system 202, may execute within the cloud computing system 202, and/or may be hosted within the cloud computing system 202, in some implementations, the processing system 201 may not be cloud-based (e.g., may be implemented outside of a cloud computing system) or may be partially cloud-based. For example, the processing system 201 may include one or more devices that are not part of the cloud computing system 202, such as device 300 of FIG. 3, which may include a standalone server or another type of computing device. The processing system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The user device 230 may include one or more devices capable of receiving, generating, storing, processing, and/or providing information associated with providing a search result, as described elsewhere herein. The user device 230 may include a communication device and/or a computing device. For example, the user device 230 may include a wireless communication device, a mobile phone, a user equipment, a laptop computer, a tablet computer, a desktop computer, or a similar type of device. As another example, the user device 230 may include a server, such as an application server, a client server, a web server, a database server, a host server, a proxy server, a virtual server (e.g., executing on computing hardware), or a server in a cloud computing system. In some implementations, the user device 230 may include computing hardware used in a cloud computing system.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with providing a search result. The device 300 may correspond to the processing system 201, the computing hardware 203, and/or the user device 230. In some implementations, the processing system 201, the computing hardware 203, and/or the user device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

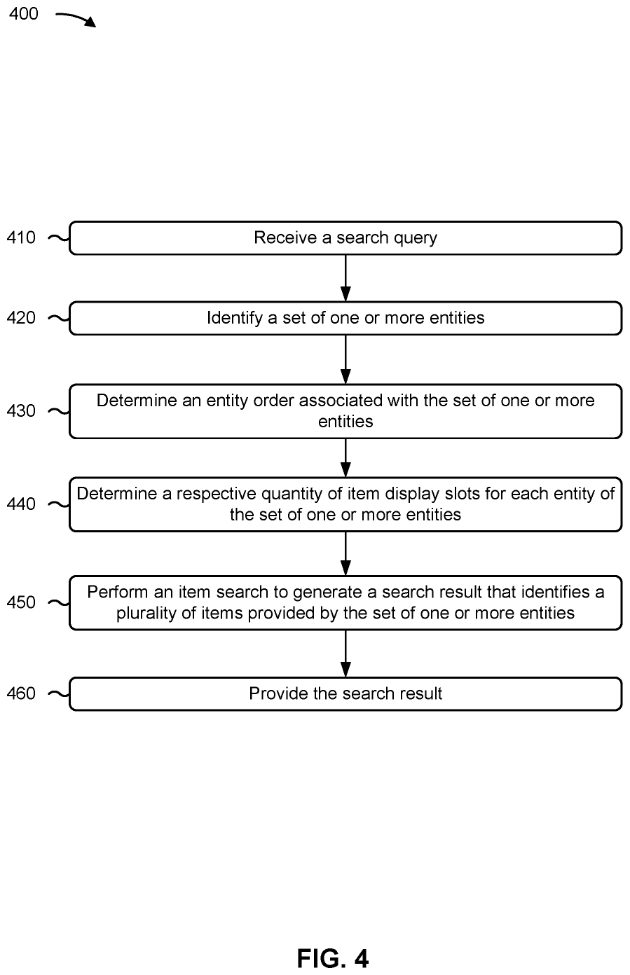

FIG. 4 is a flowchart of an example process 400 associated with providing a search result. In some implementations, one or more process blocks of FIG. 4 may be performed by the processing system 201. In some implementations, one or more process blocks of FIG. 4 may be performed by another device, or a group of devices, separate from or including the processing system 201, such as the user device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving a search query (block 410). For example, the processing system 201 (e.g., using processor 320, memory 330, input component 340, and/or communication component 360) may receive a search query, as described above in connection with reference number 102 of FIG. 1A. As an example, the processing system 201 may receive a search query that includes one or more entity characteristic parameters and one or more item characteristic parameters.

As further shown in FIG. 4, process 400 may include identifying a set of one or more entities (block 420). For example, the processing system 201 (e.g., using processor 320 and/or memory 330) may identify a set of one or more entities, as described above in connection with reference numbers 104 and 106 of FIG. 1A. As an example, the processing system 201 may identify the set of one or more entities based on the one or more entity characteristic parameters of the search query.

As further shown in FIG. 4, process 400 may include determining an entity order associated with the set of one or more entities (block 430). For example, the processing system 201 (e.g., using processor 320 and/or memory 330) may determine an entity order associated with the set of one or more entities, as described above in connection with reference number 108 of FIG. 1A. As an example, the processing system 201 may determine the entity order based on respective distances of the set of one or more entities from a physical location associated with the search query.

As further shown in FIG. 4, process 400 may include determining a respective quantity of item display slots for each entity of the set of one or more entities (block 440). For example, the processing system 201 (e.g., using processor 320 and/or memory 330) may determine a respective quantity of item display slots for each entity of the set of one or more entities, as described above in connection with reference number 110 of FIG. 1A. As an example, the processing system 201 may determine the respective quantity of item display slots for each entity of the set of entities based on respective item inventory sizes of the set of one or more entities.

As further shown in FIG. 4, process 400 may include performing an item search to generate a search result that identifies a plurality of items provided by the set of one or more entities (block 450). For example, the processing system 201 (e.g., using processor 320 and/or memory 330) may perform an item search to generate a search result that identifies a plurality of items provided by the set of one or more entities, as described above in connection with reference number 112 of FIG. 1B. As an example, the processing system 201 (e.g., using processor 320 and/or memory 330) may perform, based on the one or more item characteristic parameters, the entity order, and the respective quantity of item display slots for each entity of the set of one or more entities, the item search to generate the search result that identifies the plurality of items provided by the set of one or more entities.

As further shown in FIG. 4, process 400 may include providing the search result (block 460). For example, the processing system 201 (e.g., using processor 320 and/or memory 330) may provide the search result, as described above in connection with reference number 114 of FIG. 1B. As an example, the processing system may transmit, to the user device 230, the search result to allow the user device 230 to display the search result on a screen of the user device 230.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing search results, the system comprising:
one or more memories; and
one or more processors, communicatively coupled to the one or more memories, configured to:
receive, from a user device, a search query that includes one or more entity characteristic parameters and one or more item characteristic parameters;
identify, based on the one or more entity characteristic parameters of the search query, one or more entities associated with the one or more entity characteristic parameters;
identify a set of one or more entities, of the one or more entities, that have a particular attribute;
determine an entity order associated with the set of one or more entities;
determine a respective quantity of item display slots for each entity of the set of one or more entities;
perform, based on the one or more item characteristic parameters, the entity order, and the respective quantity of item display slots for each entity of the set of one or more entities, an item search to generate a search result that identifies a plurality of items provided by the set of one or more entities; and
transmit, to the user device, the search result to allow the user device to display the search result on a screen of the user device.

2. The system of claim 1, wherein the one or more processors, to determine the entity order associated with the set of one or more entities, are configured to:
identify, based on the one or more entity characteristic parameters, a physical location associated with the search query;
identify respective physical locations associated with the set of one or more entities; and
determine, based on the respective physical locations associated with the set of one or more entities, respective distances of the set of one or more entities from the physical location associated with the search query; and
determine the entity order based on the respective distances of the set of one or more entities from the physical location associated with the search query.

3. The system of claim 1, wherein the one or more processors, to determine the respective quantity of item display slots for each entity of the set of one or more entities, are configured to, for each entity of the set of one or more entities:
identify, for the entity, item inventory information;
determine, based on the item inventory information, an item inventory size of the entity; and
determine, based on the item inventory size of the entity, a quantity of item display slots for the entity.

4. The system of claim 1, wherein the one or more processors, to perform the item search to generate the search result that identifies the plurality of items, are configured to:
identify a particular entity, of the set of one or more entities, that is associated with a particular position of the entity order;
identify, based on the respective quantity of item display slots for each entity of the set of one or more entities, a particular quantity of item display slots for the particular entity;
identify, based on the one or more item characteristic parameters, a plurality of items provided by the particular entity; and
generate the search result to identify a particular quantity of items of the plurality of items provided by the particular entity,
wherein the particular quantity of items is equal to the particular quantity of item display slots for the particular entity.

5. The system of claim 1, wherein the one or more processors, to perform the item search to generate the search result that identifies the plurality of items, are configured to:
identify a first entity, of the set of one or more entities, that is associated with a first position of the entity order, and a second entity, of the set of one or more entities, that is associated with a second position of the entity order;
identify, based on the respective quantity of item display slots for each entity of the set of one or more entities, a first quantity of item display slots for the first entity and a second quantity of item display slots for the second entity;
identify, based on the one or more item characteristic parameters, a first plurality of items provided by the first entity and a second plurality of items provided by the second entity; and
generate the search result to identify a first quantity of items, of the first plurality of items provided by the first entity, and a second quantity of items of the second plurality of items provided by the second entity, wherein:
the first quantity of items is equal to the first quantity of item display slots for the first entity, and
the second quantity of items is equal to the second quantity of item display slots for the second entity.

6. The system of claim 5, wherein the first quantity of items, of the first plurality of items provided by the first entity, and the second quantity of items, of the second plurality of items provided by the second entity, are ordered in the search result according to relative positions of the first entity and the second entity in the entity order.

7. The system of claim 5, wherein the first quantity of items, of the first plurality of items provided by the first entity, and the second quantity of items, of the second plurality of items provided by the second entity, are ordered in the search result based on a particular item characteristic parameter of the one or more item characteristic parameters.

8. A non-transitory computer-readable medium storing a set of instructions, the set of instructions comprising:
one or more instructions that, when executed by one or more processors of a system for providing search results, cause the system to:
receive a search query that includes one or more entity characteristic parameters and one or more item characteristic parameters;
identify, based on the one or more entity characteristic parameters of the search query, a set of one or more entities;
determine an entity order associated with the set of one or more entities;
determine a respective quantity of item display slots for each entity of the set of one or more entities;
perform, based on the one or more item characteristic parameters, the entity order, and the respective quantity of item display slots for each entity of the set of one or more entities, an item search to generate a search result that identifies a plurality of items provided by the set of one or more entities; and
provide the search result.

9. The non-transitory computer-readable medium of claim 8, wherein the one or more instructions, that cause the system to determine the entity order associated with the set of one or more entities, cause the system to:
determine, based on respective physical locations associated with the set of one or more entities, respective distances of the set of one or more entities from a physical location associated with the search query; and
determine the entity order based on the respective distances of the set of one or more entities from the physical location associated with the search query.

10. The non-transitory computer-readable medium of claim 8, wherein the one or more instructions, that cause the system to determine the respective quantity of item display slots for each entity of the set of one or more entities, cause the system to:
determine, for an entity, of the set of one or more entities, an item inventory size of the entity; and
determine, based on the item inventory size of the entity, a quantity of item display slots for the entity.

11. The non-transitory computer-readable medium of claim 8, wherein the one or more instructions, that cause the system to perform the item search to generate the search result that identifies the plurality of items, cause the system to:
identify a first entity, of the set of one or more entities, that is associated with a first position of the entity order, and a second entity, of the set of one or more entities, that is associated with a second position of the entity order;
identify, based on the respective quantity of item display slots for each entity of the set of one or more entities, a first quantity of item display slots for the first entity and a second quantity of item display slots for the second entity;
identify, based on the one or more item characteristic parameters, a first plurality of items provided by the first entity and a second plurality of items provided by the second entity; and
generate the search result to identify a first quantity of items, of the first plurality of items provided by the first entity, and a second quantity of items of the second plurality of items provided by the second entity, wherein:
the first quantity of items is equal to the first quantity of item display slots for the first entity, and
the second quantity of items is equal to the second quantity of item display slots for the second entity.

12. The non-transitory computer-readable medium of claim 11, wherein the first quantity of items, of the first plurality of items provided by the first entity, and the second quantity of items, of the second plurality of items provided by the second entity, are ordered in the search result according to relative positions of the first entity and the second entity in the entity order.

13. The non-transitory computer-readable medium of claim 11, wherein the first quantity of items, of the first plurality of items provided by the first entity, and the second quantity of items, of the second plurality of items provided by the second entity, are ordered in the search result based on a particular item characteristic parameter of the one or more item characteristic parameters.

14. The non-transitory computer-readable medium of claim 8, wherein the one or more instructions, that cause the system to provide the search result, cause the system to:
transmit, to a user device, the search result to allow the user device to display the search result on a screen of the user device.

15. A method for providing search results, comprising:
identifying, by a system and based on a search query, a set of one or more entities;
determining, by the system, an entity order associated with the set of one or more entities;
determining, by the system, a respective quantity of item display slots for each entity of the set of one or more entities;
performing, based on the search query, the entity order, and the respective quantity of item display slots for each entity of the set of one or more entities, an item search to generate a search result that identifies a plurality of items provided by the set of one or more entities; and
providing the search result.

16. The method of claim 15, wherein determining the entity order associated with the set of one or more entities comprises:
determining the entity order based on respective distances of the set of one or more entities from a physical location associated with the search query.

17. The method of claim 15, wherein determining the respective quantity of item display slots for each entity of the set of one or more entities comprises:
determining the respective quantity of item display slots for each entity of the set of entities based on respective item inventory sizes of the set of one or more entities.

18. The method of claim 15, wherein performing the item search to generate the search result that identifies the plurality of items comprises:
generating the search result to identify a particular quantity of items, of a plurality of items provided by a particular entity of the set of one or more entities, that is equal to a particular quantity of item display slots for the particular entity.

19. The method of claim 15, wherein performing the item search to generate the search result that identifies the plurality of items comprises:
identifying, based on the search query, a first plurality of items provided by a first entity, of the set of one or more entities, and a second plurality of items provided by a second entity of the set of one or more entities; and
generating the search result to identify a first quantity of items, of the first plurality of items provided by the first entity, and a second quantity of items of the second plurality of items provided by the second entity, wherein:
the first quantity of items is equal to a first quantity of item display slots for the first entity, and
the second quantity of items is equal to a second quantity of item display slots for the second entity.

20. The method of claim 19, wherein the first quantity of items, of the first plurality of items provided by the first entity, and the second quantity of items, of the second plurality of items provided by the second entity, are ordered in the search result according to relative positions of the first entity and the second entity in the entity order.
